(19) United States
(12) Patent Application Publication
(10) Pub. No.: US 2003/0110233 A1
(43) Pub. Date: Jun. 12, 2003

(54) Reflective memory system and method capable of dynamically sizing data packets

(75) Inventor: Scott D. Prall, Madison, AL (US)

Correspondence Address: LANIER FORD SHAVER & PAYNE, P O BOX 2087, HUNTSVILLE, AL, 35804, US

(73) Assignee: VMIC, Huntsville, AL

(21) Appl. No.: 10/013,324

(22) Filed: Dec. 10, 2001

(51) Int. Cl. G06F 15/167; G06F 13/28; G06F 13/00; G06F 12/14; G06F 12/16

(52) U.S. Cl. 709/213; 711/114

(57) ABSTRACT

A reflective memory system utilizes reflective memory and a transmit manager. The transmit manager is configured to packetize, into a plurality of data packets, write data that is associated with data writes to the reflective memory. The transmit manager is further configured to dynamically size the plurality of data packets and to cause the data packets to be transmitted to a communication network.

### BACKGROUND OF THE INVENTION

1. Field of the Invention

The present invention generally relates to reflective memory systems and, in particular, to a reflective memory system and method capable of communicating data packets that have been dynamically sized for improved transmission efficiency.

2. Related Art

Reflective memory systems typically include a plurality of nodes that are each coupled to a network. Each node includes reflective memory, and when data is written to an address in the reflective memory of one node from a local source, the node passes the data to the network, which routes the data to each of the other nodes within the reflective memory system. Each of the other nodes then writes the foregoing data into the same address of its reflective memory. Thus, the data of the reflective memory in any one node should correspond to or “reflect” the data of the reflective memory of the other nodes.

Maintaining the reflective nature of the memory within a reflective memory system imposes a significant transmission burden for the system's network. In this regard, a write to any one node causes communication messages to be transmitted across the network to all of the other nodes so that the other nodes can update their memory based on the data of the foregoing write. Thus, as the number of nodes in such a reflective memory system increases, the amount of data transmitted by the network increases drastically.

Moreover, a heretofore unaddressed need exists in the industry for providing a dynamic memory system capable of communicating between nodes more efficiently.

### SUMMARY OF THE INVENTION

The present invention overcomes the inadequacies and deficiencies of the prior art as discussed hereinbefore. Generally, the present invention provides a reflective memory system and method capable of communicating dynamically sized data packets.

In architecture, the reflective memory system of the present invention utilizes reflective memory and a transmit manager. The transmit manager is configured to packetize, into a plurality of data packets, write data that is associated with data writes to the reflective memory. The transmit manager is further configured to dynamically size the plurality of data packets and to cause the data packets to be transmitted to a communication network.

The present invention can also be viewed as providing a method for use in a reflective memory system that includes a plurality of nodes communicatively coupled to a communication network. The method can be broadly conceptualized by the following steps: detecting data writes to reflective memory within the reflective memory system; packetizing, into a plurality of data packets, write data associated with the data writes; dynamically sizing the data packets; and communicating the plurality of data packets to the plurality of nodes via the communication network.

Various features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating a reflective memory system in accordance with the prior art.

FIG. 2 is a block diagram illustrating a reflective memory system in accordance with a preferred embodiment of the present invention.

FIG. 3 is a block diagram illustrating a more detailed view of a node depicted in FIG. 2.

FIG. 4 is a block diagram illustrating a more detailed view of a reflective memory unit depicted in FIG. 3.

FIG. 5 is a block diagram illustrating an exemplary data packet packetized by the reflective memory unit depicted in FIG. 4.

FIG. 6 is a flow chart illustrating the architecture and functionality of a transmit manager depicted in FIG. 4.

FIG. 7 is a flow chart illustrating the architecture and functionality of a receive manager depicted in FIG. 4 in receiving a data packet.

FIG. 8 is a flow chart illustrating the architecture and functionality of the receive manager depicted in FIG. 4 in processing data stored within a ring buffer.

### DETAILED DESCRIPTION OF THE INVENTION

In general, the present invention pertains to a reflective memory system capable of dynamic packet sizing. In this regard, a reflective memory system in accordance with the present invention includes a plurality of nodes communicatively coupled to a serial network. When a local write occurs in reflective memory of one of the nodes, the data of the local write is packetized and transmitted to the other nodes via the network. The packet or packets utilized to transmit the data are dynamically sized in order to increase the transmission efficiency in transmitting the data to the other nodes.

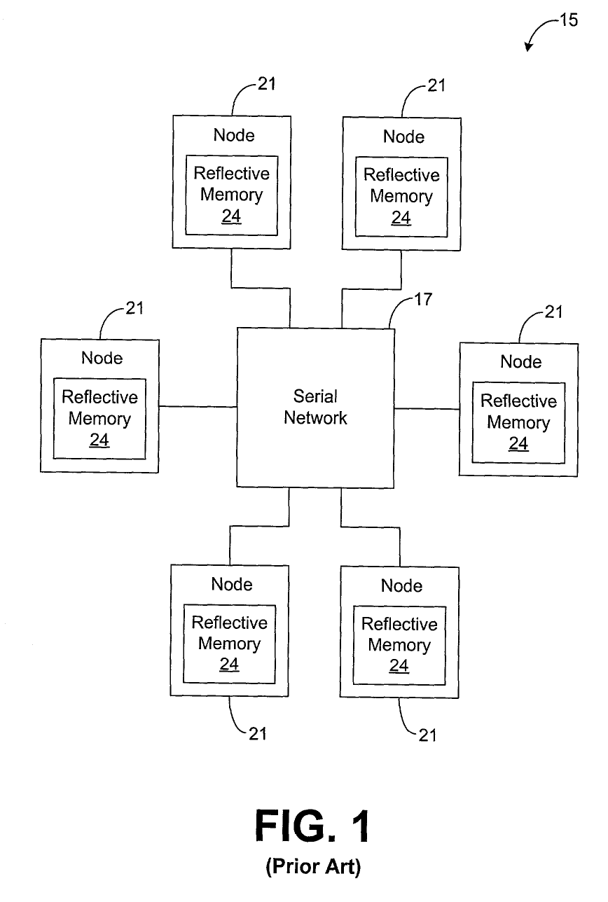

To better illustrate the inventive features of the present invention, it may be helpful to first describe the operation of typical reflective memory systems. FIG. 1 depicts a typical reflective memory system 15 of the prior art. As can be seen by referring to FIG. 1, the reflective memory system 15 includes a serial network 17 communicatively coupled to a plurality of nodes 21, and each of the nodes 21 includes reflective memory 24. When data is written into an address of the reflective memory 24 of one of the nodes 21 in response to a local write, the one node 21 packetizes the data into one or more packets and passes the packet or packets to the serial network 17.

Each packet includes overhead information and data. The overhead information includes various information, including, but not limited to, the address where the data of the data packet is written in reflective memory 24 and a node identifier identifying the first node 21 where the data was originally written into reflective memory 24. The network 17 transmits each packet to another node 21. The other node 21, utilizing the reflective memory addresses included in the overhead information, writes the data included in the packets to the same address in its reflective memory 24. The other node 21 then repacketizes the data into new packets and passes the new packets to the network 17, which transmits each new packet to yet another node 21. This process is repeated until each node 21 has updated its reflective memory 24 based on the write that originally occurred in the first node 21. Note that the node identifier included in the overhead information is not changed by any of the nodes 21. Thus, the same node identifier is included in each of the aforementioned packets.

To ensure that the reflective memory 24 of each node 21 is updated in response to a local write occurring in any one node 21, the network 17 consistently transmits data packets to the nodes 21 in a particular order or sequence. Thus, whenever one of the nodes 21 passes a data packet to the network 17, the network 17 is generally designed to always transmit the data packet to the same other node 21, unless the configuration or sequence of the network 17 is for some reason changed or redesigned (e.g., nodes 21 are added to or removed from the system 15).

Thus, the data of any data packet originally passed to the network 17 by one node 21 is guaranteed to be transmitted to each node 21 within the system 15. After the last of the other nodes 21 has received the data and repacketized the data into new packets, these new packets should then be transmitted, according to the particular order or sequence, to the first node 21 that originally passed the data to the network 17. The node identifier of these new packets should identify the first node 21, which ignores these new data packets and refrains from repacketizing the data. In other words, once the same node 21 where the local write originally occurred receives the data of the local write, the process of updating the reflective memory 24 within the system 15 is complete and is, therefore, terminated.

Note that a node 21 is aware of when a data packet is to be ignored by analyzing the packet's node identifier. In this regard, if the packet's node identifier identifies the same node 21 that receives the packet, then the receiving node 21 is configured to discard the packet without storing the packet's data to memory 24 and without repacketizing the packet's data.

It should be noted that each packet communicated via network 17 is typically of a fixed length in which the overhead information, particularly the reflective memory address and the node identifier, always occupies certain bits within each packet and in which data always occupies the other bits within each packet. For example, the first half of each packet may include the overhead information, and the second half of each packet may include data. Thus, any node 21 receiving a data packet from the network 17 should be able to successfully extract and read the overhead information and the data.

Unfortunately, the fixed length nature of the data packets decreases the overall transmission efficiency of the system 15. In this regard, the amount of data associated with different writes to reflective memory 24 may be different. Moreover, for any local data write, the data portion of a packet may be larger than the amount of data written to reflective memory 24. Thus, some of the data bits included in the packet are empty or in other words convey no usable information. However, for other writes, the data portion of a packet may be smaller than the amount of data written to reflective memory 24. Thus, all of the data written to reflective memory 24 is unable to fit within a single data packet, and multiple data packets must be passed over the network 17. Each additional data packet includes not only write data that could not fit into a single data packet but also includes overhead information. As a result, the network 17 is burdened with additional overhead information that would not be necessary if fewer data packets could have been utilized to communicate the write data.

Moreover, the transmission efficiency of the system 15 can be increased if the data packets communicated over the network 17 can be dynamically sized. In this regard, if the data portion of a data packet is dynamically changed, then the data portion can be increased for the transmission of larger amounts of data in order to reduce the number of packets needed to transmit the data. Furthermore, when smaller amounts of data need to be transmitted, the data portion can be decreased so that a greater percentage of the bits within the data portion are utilized to transmit usable information. Thus, dynamically changing the data portion of data packets communicated over the network 17 can decrease the amount of overhead information and/or the amount of empty bits communicated by the network 17, thereby increasing the transmission efficiency of the system 15.

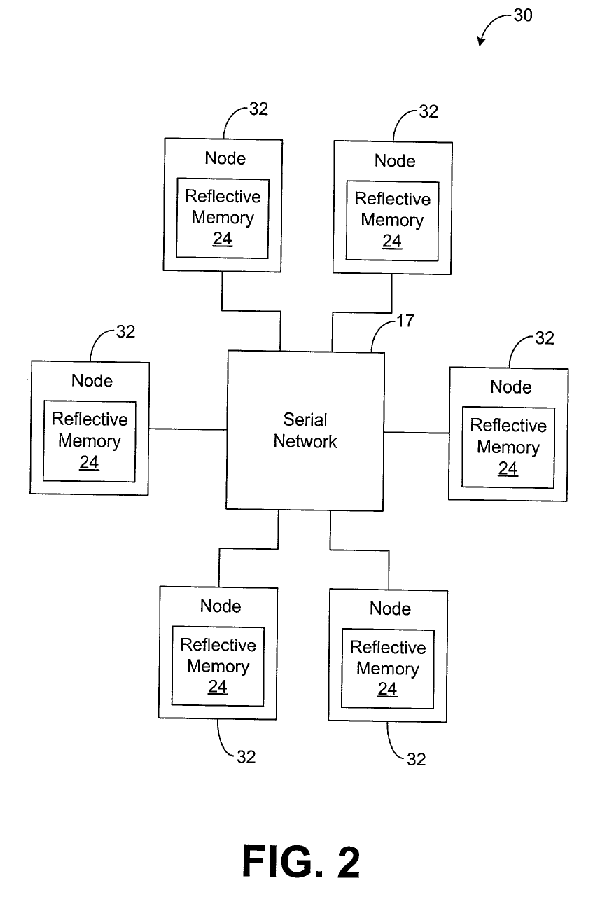

FIG. 2 depicts a reflective memory system 30 in accordance with a preferred embodiment of the present invention. The system 30 includes a serial network 17 communicatively coupled to a plurality of nodes 32, and each of the nodes 32 includes reflective memory 24. When a data write occurs in the reflective memory 24 of one of the nodes 32, the one node 32 packetizes the write data into one or more packets and passes these packets to the network 17. The network 17 then routes the packets to another node 32, which updates its reflective memory 24 with the write data from the received packets. The other node 32 then repacketizes the write data into one or more new packets and then passes the new packets to the network 17, which routes the new packets to yet another node 32. This process is preferably repeated until each node 32 has updated its reflective memory 24 based on the write data.

Thus, the operation of the system 30 is similar to the operation of the conventional reflective memory system 15. However, instead of creating and transmitting data packets of fixed lengths, each node 32 is preferably configured to dynamically change the lengths of the data packets based on the amount of data that is to be communicated. For example, if a node 32 is ready to transmit a large amount of write data for a particular data write, the node 32 preferably increases the length of a packet utilized to transmit the write data. Thus, a smaller number of data packets may be utilized to communicate all of the write data. However, if a node 32 is ready to transmit a small amount of write data for a particular data write, then the node 32 preferably decreases the length of a packet utilized to transmit the write data. Thus, the number of unused data bits in the packet should be reduced. Moreover, for the reasons previously set forth above, dynamically changing the length of the data packets communicated within the system 30 enables more efficient data communication and reduces the overall transmission burden of the system 30.

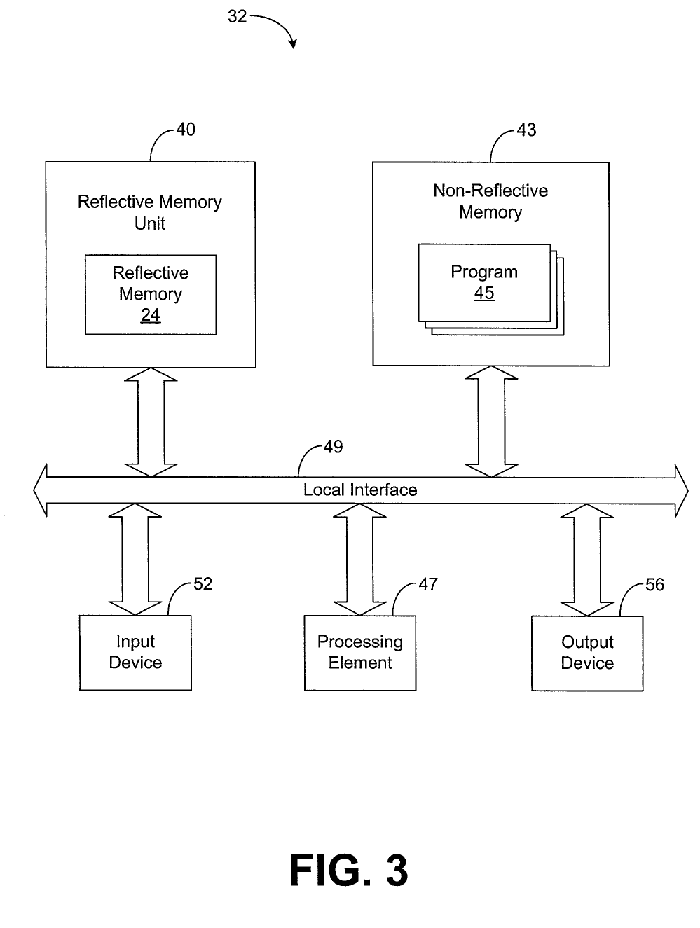

FIG. 3 depicts a more detailed view of one of the nodes 32 in accordance with a preferred embodiment of the present invention. The node 32 shown by FIG. 3 includes a reflective memory unit 40 that includes the node's reflective memory 24. The reflective memory unit 40 preferably controls the process of updating the reflective memory 24 and of communicating with the network 17. Note that the techniques employed by the reflective memory unit 40 for updating reflective memory 24 and communicating with the network 17 will be described in more detail hereafter.

The node 32 of FIG. 3 may also include non-reflective memory 43. Unlike reflective memory 24, data may be written to non-reflective memory 43 without invoking updates in other nodes 32. In other words, the data stored in non-reflective memory 43 is not necessarily shared by the nodes 32 of the system 30. Programs 45 for performing various functionality may be stored in the non-reflective memory 43 and/or reflective memory 24. Such programs 45 may be executed via one or more processing elements 47, such as a digital signal processor (DSP) or a central processing unit (CPU), for example, that communicate to and drive the other elements within the node 32 via a local interface 49, which can include one or more buses. Furthermore, an input device 52, for example, a keyboard or a mouse, can be used to input data from a user of the node 32, and an output device 56, for example, a screen display or a printer, can be used to output data to the user. Note that each of the nodes 32 within the system 30 may be configured similar to or identical to the node 32 shown by FIG. 3.

Node Transmission

At various times, the node 32 shown by FIG. 3 may be configured to write data to its reflective memory 24. For example, one of the programs 45 may be configured to store, when executed by processing element 47, data in memory 24. Upon execution of such a program 45, a data write to the reflective memory 24 occurs. When a data write to the reflective memory 24 occurs, the reflective memory unit 40 receives write data (i.e., data to be stored in reflective memory 24) and a memory address identifying the location in memory 24 where the write data is to be stored. The reflective memory unit 40 stores the write data into its reflective memory 24 at a location corresponding to the memory address and then packetizes the write data into one or more data packets. The reflective memory unit 40 then passes these data packets to the serial network 17 in order to enable updates to the reflective memory 24 of other nodes 32 according to techniques generally described above.

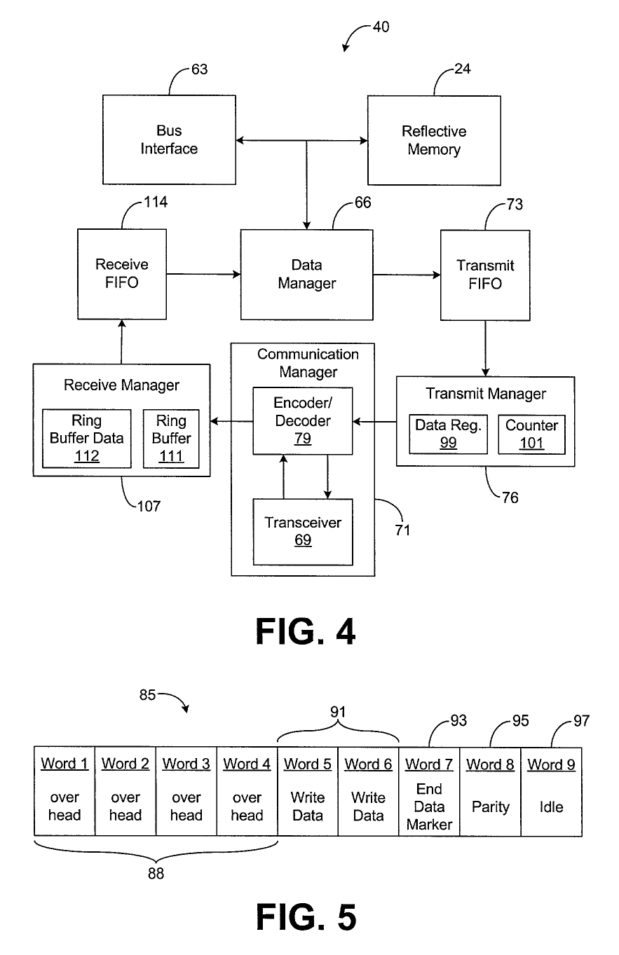

FIG. 4 depicts a more detailed view of the reflective memory unit 40. As shown by FIG. 4, the unit 40 preferably includes a bus interface 63 that receives data from the local interface 49 (FIG. 3) and/or that transmits data to the local interface 49. During a data write, the write data and the memory address of the data write are transmitted from the bus interface 63 to the reflective memory 24 where the write data is stored. Note that the reflective memory 24 may be any type of memory suitable for storing data. In the preferred embodiment, the reflective memory 24 is comprised of random access memory (RAM), such as synchronous dynamic RAM (SDRAM), for example.

A data manager 66 monitors the data transmitted from the bus interface 63 to the reflective memory 24 and, based on this data, determines when a local data write occurs. A data write is generally considered to be “local” when the write data and memory address associated with the data write are transmitted from the bus interface 63 to the reflective memory 24. An example of a non-local data write would be a data write that is received from the network 17 via a transceiver 69 within a communication manager 71, which will be described in more detail hereafter.

When a data write occurs, the data manager 66 passes the write data associated with the data write (i.e., the data actually written into memory 24 in response to the data write) to a transmit first in, first out device (transmit FIFO) 73, which buffers the write data. The data manager 66 also provides, to the transmit FIFO 73, a memory address indicative of where the write data is stored in reflective memory 24. When interfacing data from a data write with the transmit FIFO 73 in the preferred embodiment, the data manager 66 also preferably passes, to the transmit FIFO 73, a node identifier that identifies the manager's node 32. The transmit FIFO 73 buffers the information received from the data manager 66.

The memory address, node identifier, and write data associated with same data write (i.e., transmitted to the transmit FIFO 73 in response to the same data write) shall be referred to collectively as a “write burst.” In parallel with each word of a write burst, the data manager 66 preferably stores a “burst identifier,” which can be one or more bits of information, and the data manager 66 preferably assigns a different burst identifier to each consecutive write burst. As an example, in the preferred embodiment, the burst identifier is a two bit value, and the data manager 66 increments the burst identifier after completing a transfer of a write burst to the transmit FIFO 73. As a result, the next write burst passed to the transmit FIFO 73 is assigned a different (i.e., an incremented) burst identifier. The burst identifier permits an association of the transmit FIFO's contents with a specific write burst as the contents are being read from the transmit FIFO 73. Utilization of the burst identifier will be described in more detail hereafter.

A transmit manager 76 reads the buffered information associated with the aforementioned write burst out of the transmit FIFO 73 and defines one or more data packets for transmission across the network 17 based on the buffered information. In other words, the transmit manager 76 packetizes the write data of the write burst. The transmit manager 76 passes the packetized data to the communication manager 71. An encoder/decoder 79 within the communication manager 71 encodes the packetized data for transmission across network 17 via any conventional encoding technique. The encoder/decoder 79 also serializes the packetized data and serially passes the packetized data to the transceiver 69, which interfaces this data with the network 17. The network 17 then transmits the packetized data to another node 32 according to a predefined sequence, as described hereinbefore.

It should be noted that there are a variety of methodologies that may be employed by the transmit manager 76 to packetize the write data of the write burst. FIG. 5 depicts an exemplary data packet 85 provided by the transmit manager 76. The data packet 85 includes an overhead portion 88, a data portion 91, an end data marker 93, a parity portion 95, and an idle pattern 97. The overhead portion 88, the end data marker 93, the parity portion 95, and the idle pattern 97 are preferably of fixed length. In other words, the lengths of the foregoing portions, in the preferred embodiment, do not change for different data packets 85. However, the length of the data portion 91 is dynamically controlled by the transmit manager 76 and, therefore, can change from packet-to-packet.

In the example shown by FIG. 5, the first four words passed to the encoder/decoder 79 by the transmit manager 76 define the overhead portion 88. This portion 88 includes overhead information, such as a node identifier and a memory address, which will be referred to hereafter as the “write address.” Note that the foregoing node identifier is preferably the same node identifier passed to the transmit FIFO 73 by the data manager 66 for the write burst, and the foregoing memory address is indicative of the reflective memory location where the data portion 91 is to be stored.

As the transmit manager 76 is passing the overhead portion 88 to the encoder/decoder 79, the transmit manager 76, in the preferred embodiment, is simultaneously reading write data associated with the same write burst from the transmit FIFO 73. After passing the overhead portion 88 to the encoder/decoder 79, the transmit manager 76 immediately begins to pass one or more words of the write data to the encoder/decoder 79. The transmit manager 76 continues passing the write data to the encoder/decoder 79 in this way until a maximum number of words of the write data has been passed or until there is no more write data associated with the same write burst to be read out of the transmit FIFO 73. Note that the latter condition may occur because either all of the write data of the write burst has been passed through the transmit FIFO 73 or because the data manager 66 has yet to finish passing all such write data to the transmit FIFO 73. Note that the transmit manager 76 may utilize the burst identifier to determine whether the contents of the transmit FIFO 73 being read from the transmit FIFO 73 are associated with the same write burst as the write data being packetized for the current data packet 85.

As the transmit manager 76 continues to pass more words of write data to the encoder/decoder 79, the data portion 91 gets larger. Indeed, the example shown by FIG. 5 shows two words in the data portion 91. However, depending on the amount of write data associated with the write burst, the number of words in the data portion 91 could be increased up to the maximum number of words that may be transmitted in any single packet 85. Note that this maximum number is preferably set based on various factors, which will be described in more detail hereinafter.

Once the maximum number of data words within portion 91 has been exceeded or once there is no more write data associated with the same write burst within the transmit FIFO 73, the transmit manager 76 transmits the end data marker 93 as the next word after the last data word within portion 91. The end data marker 93 is a predefined pattern of bits that marks the end of the data portion 91. Thus, by detecting the end data marker 93, any element that receives the end data marker 93 may be aware that the data portion 91 has ended and that the next received word of packet 85 should, therefore, define the parity portion 95. The parity portion 95 includes parity data that may be utilized to ensure the integrity of the packet 85, via any conventional parity technique. Note that a new set of data packets 85 is preferably transmitted for each separate write burst. Thus, the write data included in the data portion 91 of any single data packet 85 is preferably associated with the same write burst.

After passing the parity portion 95 to the encoder/decoder 79, the transmit manager 76 passes an idle pattern 97. The idle pattern 97 is a predefined pattern of bits that marks the end of the packet 85. The idle pattern 97 is recognizable by the network 17 for identifying the beginnings and/or endings of data packets 85 being communicated by the network 17. Note that the order of the different portions of the data packet 85 can be changed or rearranged without departing from the principles of the present invention. It should also be noted that the transmit manager 76 may include memory (e.g. one or more data registers 99) for storing overhead information. In this regard, as described hereinabove, the transmit manager 76 terminates the data portion 91 when there is (1) no more write data presently in the transmit FIFO 73 and associated with the same write burst or (2) when the maximum number of words within the data portion 91 is exceeded. If all of the write data from the write burst is not transmitted in the first data packet 85, then one or more additional data packets may be utilized to pass the remaining write data to the encoder/decoder 79 and to the network 17. Each data packet 85 including write data of a particular write burst also includes overhead information derived from the write address of the particular write burst and includes the node identifier passed to the transmit FIFO 73 by the data manager 66 for the particular write burst.

Thus, the transmit manager 76 preferably stores, into one or more data registers 99, the write address and node identifier of a write burst being read from the transmit FIFO 73 for the local data write. The write address and node identifier stored in the data registers 99 for the write burst are included in the overhead portion 88 of each data packet 85 including write data from the same write burst. In order for the write address to consistently reflect the proper reflective memory address where the data portion 91 of the next packet 85 is to be stored, the transmit manager 76, when passing a data packet 85 to the encoder/decoder 79, preferably increments the stored write address for each data word passed in the data portion 91 of the packet 85. Therefore, after the data packet 85 is completely passed, the write address is properly offset such that it indicates the reflective memory address where the data portion 91 of the next data packet 85 is to be stored, provided that the foregoing data packets 85 are both associated with the same write burst. Note that once the transmit manager 76 begins to pass write data from a new write burst, the write address and the node identifier in the data registers 99 associated with the previous write burst may then be overwritten by the write address and the node identifier associated with the new write burst.

Since a data packet 85 may be terminated when its data portion 91 exceeds a predefined length, it is desirable for the transmit manager 76 to track the number of data words included in the data packet 85 being formed by the transmit manager 76. A variety of techniques may be employed by the transmit manager 76 in order to determine the number of data words included in each data packet 85. In the preferred embodiment, the transmit manager 76 utilizes a word counter 101. The word counter 101 is preferably a data register that maintains a value indicative of the number of data words included in the data portion 91 of the packet 85 being formed by the transmit manager 76.

Moreover, the transmit manager 76 preferably sets the data counter 101 to zero when the transmit manager 76 begins to form a new data packet 85. For each word of write data read from the transmit FIFO 73 and included in the data portion 91 of the new data packet 85, the transmit manager 76 increments the value in the word counter 101. Therefore, the value in the word counter should correspond to the number of words included in the data portion 91 of the data packet 85 being formed by the transmit manager 73. However, as set forth above, other techniques may be employed by the transmit manager 73 in other embodiments in order to determine the number of data words that have been included in the data portion 91.

As set forth above, the transmit manager 76 preferably includes write data from only the same write burst in the same packet 85. In this regard, if the transmit manager 76 begins to read, from the transmit FIFO 73, write data from a new write burst, then the transmit manager 76 terminates the data packet 85 being formed by the transmit manager 76. As a result, the terminated data packet 85 includes write data from only a previous write burst, and the write data from the new write burst is included in one or more other data packets 85.

There are a variety of methodologies that may be employed to inform the transmit manager 76 when it has read all of the write data of a previous data write and is now reading write data from a new data write. As described above, the foregoing is enabled, in the preferred embodiment, via a “burst identifier” that is passed from the data manager 66 to the transmit FIFO 73.

In this regard, the data manager 66 preferably passes write data from various write bursts iteratively to the transmit FIFO 73. In other words, when the data manager 66 is passing to the transmit FIFO 73 write data of a first write burst, the data manager 66 is preferably designed to refrain from passing write data of another write burst before the data manager 66 has passed all of the write data of the first write burst. Furthermore, in parallel to the write data being passed to the FIFO 73, the data manager 66 passes the burst identifier to the transmit FIFO 73. The data manager 66 preferably does not change the value of the burst identifier as long as it is passing write data from the same write burst. Once the data manager 66 begins passing write data from another write burst, the data manager 66 preferably transitions (e.g., increments) the value of the burst identifier.

In addition, the transmit FIFO 73 preferably samples the burst identifier as the transmit FIFO 73 is receiving each new word of a write burst. The sample taken with a new word is correlated with the new word. As an example, the burst identifier sample, or “burst ID sample,” may be clocked through the transmit FIFO 73 along with its correlated word of a write burst such that the burst ID sample and its correlated word are ready to be read out of the transmit FIFO 73 by the transmit manager 76 on the same read.

Moreover, upon reading a new word of write data from the transmit FIFO 73, the transmit manager 76 preferably checks the word's correlated burst ID sample to determine if the correlated burst ID sample is different than the burst ID sample of the write data word previously read from the transmit FIFO 73. If the two burst ID samples are different, then the transmit manager 76 determines that the new word is associated with a different write burst than the word that was previously read from the transmit FIFO 73 and inserted into the data portion 91 of the data packet 85 being formed by the transmit manager 76. Therefore, if the two samples are different, the transmit manager 76 refrains from inserting the new word into the foregoing data packet 85 and terminates the foregoing packet 85. The transmit manager 76 then inserts the new word in the next packet 85 formed by the transmit manager 76. By performing these techniques, the transmit manager 76 ensures that all of the data included in any given packet 85 is associated with the same write burst. Note that other methodologies may be employed to achieve the foregoing.

Node Reception

When the transceiver 69 receives a data packet 85 from the network 17, the transceiver 69 passes the packet 85 to the encoder/decoder 79, which decodes the data packet 85 via any suitable decoding technique known in the art. The encoder/decoder 79 also converts the data packet 85 from serial into parallel data, and passes the data packet 85 to a receive manager 107.

The receive manager 107 temporarily stores each received data packet 85 into memory. In the preferred embodiment, such memory is a ring buffer 111. The receive manager 107 continues to store data packets 85 into the ring buffer 111 as they are received from the encoder/decoder 79. In the preferred embodiment, the receive manager 107 maintains a storage pointer that points to the ring buffer location where the newly received is to be stored. In this regard, the first word of a data packet 85 received from the encoder/decoder 79 is stored at the ring buffer address pointed to by the storage pointer. Upon receiving the first word, the receive manager 107 updates (e.g., increments) the storage pointer such that it points to the next ring buffer location where the next word of the data packet 85 is to be stored. By updating the storage pointer in this way for each data word received by the receive manager 107, the storage pointer should point to the ring buffer address where the first word of the next data packet 85 is to be stored once each word of the previous data packet 85 has been received by the ring buffer 111.

While the receive manager 107 is receiving a data packet 85, the receive manager 107 preferably evaluates the data packet 85 for validity. As an example, the receive manager 107 preferably employs typical parity checking techniques for checking the data packet 85 for parity errors. If parity errors or other types of errors are detected, then the receive manager marks the data packet 85 as invalid. The receive manager 107 also marks the data packet 85 as invalid if the node identifier in the data packet 85 identifies the receiving node 32 (i.e., the node 32 of the receive manager 107 that is evaluating the data packet 85).

There are a variety of methodologies that may be employed to mark a data packet 85 as invalid. In the preferred embodiment, the receive manager 107 maintains a validity flag within ring buffer data 112 for each data packet 85 stored in the ring buffer 111. Note that the ring buffer data 112 may be stored in memory separate from the memory (e.g., the ring buffer 111) storing the data packets 85, if desired.

When asserted, the validity flag indicates that the associated data packet 85 is invalid. When deasserted, the validity flag indicates that the associated data packet 85 is valid. Therefore, the receive manager 107 is configured to deassert each validity flag unless the receive manager 107, when evaluating the data packet 85 associated with the flag, determines that the data packet 85 is invalid. If the receive manager 107 determines that the data packet 85 is invalid, then the receive manager 107 asserts the associated validity flag.

Note that there are a variety of methodologies that may be utilized to determine which validity flags are associated with which data packets 85 stored within the ring buffer 111. In the preferred embodiment, the foregoing is achieved by storing a value, referred to hereafter as a “data packet length,” in the ring buffer data 112 for each validity flag defined in the data 112. Each validity flag and its correlated data packet length shall be referred to collectively hereafter as a “ring buffer data set.” The data packet length of a ring buffer data set is preferably a value indicative of the number of words included in the data packet 85 associated with the validity flag that is also included in the ring buffer data set. Techniques for utilizing the data packet lengths and validity flags for evaluating the validity of different data packets 85 stored in the ring buffer 111 will be described in more detail hereinafter.

Moreover, in order to create the ring buffer data 112, for each data packet 85 received by the receive manager 107, the receive manager 107 begins to evaluate the data packet 85 as it is being received. Once the receive manager 107 receives both the node identifier and the parity portion 95 of the data packet 85, the receive manager 107 should have received sufficient information for marking the data packet 85 as valid or invalid. Thus, after receiving the parity portion 95, the receive manager 107 appropriately defines a ring buffer data set that is correlated with the data packet 85 being received. Note that there are various well-known techniques that may be employed to correlate a ring buffer data set with its respective data packet 85.

If a data packet 85 is determined to be invalid, then the receive manager 107 refrains from passing any data of such packet 85 to a receive FIFO 114 and allows such data to be eventually overwritten in the ring buffer 111. However, if the data packet 85 is determined to be valid, the receive manager 107 passes the data packet 85 to the receive FIFO 114, which buffers the data packet 85. Note that the processes of receiving packet data from the encoder/decoder 79 and of passing packet data to the receive FIFO 114 may be done concurrently such that receive manager 85, when appropriate, preferably passes packet data to the receive FIFO 114 while receiving packet data from the encoder/decoder 79.

In order to determine when to pass packet data to the receive FIFO 114, the receive manager 107 preferably maintains a pointer, referred to hereafter as a “reading pointer,” that points to the ring buffer location where data is to be read out of the ring buffer 111 and written to the receive FIFO 114. The reading pointer preferably follows the storage pointer through the ring buffer 111 without ever passing the storage pointer.

Thus, after a data packet 85 has been stored in the ring buffer 111, the reading pointer will eventually move through the ring buffer 111 until it points to the location storing the first word of the data packet 85. When this occurs, the receive manager 107 consults the ring buffer data 112 to determine whether or not the data packet 85 is valid. More specifically, the receive manager 107 analyzes the ring buffer data set correlated with the data packet 85 and determines whether or not the validity flag within this set is asserted. If the foregoing flag is deasserted, the data packet 85 is valid, and the receive manager 107 passes the data packet 85 to the receive FIFO 114.

As each word is read out of the ring buffer 111, the receive manager 107 updates (e.g., increments) the reading pointer to cause it to point to the next ring buffer address. Therefore, once the entire data packet 85 is read out of the ring buffer 111, the reading pointer points to the next data packet 85 stored in the ring buffer 111. Note that this next data packet 85 is preferably the data packet 85 received by the receive manager 107 immediately after the data packet 85 just read out of the ring buffer 111.

Once the next data packet 85 is reached by the reading pointer, the foregoing process can be repeated for the next data packet 85 to determine whether or not the next data packet 85 should be passed to the receive FIFO 114. Note that the receive manager 107 is preferably aware of when the next data packet 85 is reached by the reading pointer based on the data packet length included in the aforementioned ring buffer data set (i.e., the ring buffer data set correlated with the data packet 85 being read out of the ring buffer 111). In this regard, when an “n” number of data words has been read out of the ring buffer 111 (where “n” is equal to the value of the data packet length), then the next data packet 85 is reached.

If the validity flag of the data packet 85 being pointed to by the reading pointer is asserted, then the data packet 85 is invalid. Therefore, the reading pointer skips the data packet 85 without the receive manager 107 passing the data packet 85 to the receive FIFO 114. This may be accomplished by advancing the reading pointer to the next data packet 85 (e.g., increments the reading pointer by the value of the data packet length associated with the invalid data packet 85) without reading the aforementioned data packet 85 out of the ring buffer 111.

It should be noted that the receive manager 107 is preferably configured to ensure that a data packet 85 is not passed to the receive FIFO 114 until an evaluation of the packet's validity is performed. As set forth hereinabove, such an evaluation is preferably not complete until at least the parity portion 95 of a data packet 85 is received by the receive manager 107. Furthermore, in some situations, particularly when the data packet 85 being stored to the ring buffer 111 is relatively long, the reading pointer may reach the start of a data packet 85 before the receive manager 107 has been able to complete its evaluation of the data packet 85 and set the packet's validity flag. In such situations, it may be desirable to stall the process of reading from the ring buffer 111 until the receive manager 107 has properly evaluated the data packet 85 and set the packet's validity flag.

The data manager 66 is configured to read data packets 85 from the receive FIFO 114. For each data packet 85 read from the receive FIFO 114, the data manager 66 stores the write data within the packet's data portion 91 in reflective memory 24 at a location corresponding to the reflective memory address (i.e., the “write address”) included in the packet's header. The data manager 66 also passes the foregoing memory address and the data portion 91 to the transmit FIFO 73, and this data is packetized into one or more new data packets 85 by the transmit manager 76 according to the same techniques described above. These new data packets 85 are then passed to the network 17, which transmits the new data packets 85 to another node 32. Moreover, the packet 85 read out of the receive FIFO 114 is effectively treated as another data write to the reflective memory 24.

Note that it is possible for a data packet 85 to be buffered in the receive FIFO 114 when a local data write (e.g., a data write from the bus interface 63) occurs. In such a situation, the data packet 85 in the receive FIFO 114 is preferably given higher priority by the data manager 66 such that the data manager 66 stalls the local data write until the buffered data packet 85 is serviced by the data manager 66. Therefore, local data writes are only serviced when no complete data packets 85 are presently buffered by the receive FIFO 114. Giving higher priority to the data packets 85 in the receive FIFO 114 helps to ensure that data overruns in the receive FIFO 114 and/or ring buffer 111 do not occur.

As set forth hereinabove, the maximum threshold set for the data portion 91 (FIG. 5) can be based on various factors. These factors may include the size of the ring buffers 111 and/or the desired node latency of the system 30. In this regard, as described above, the reading pointer may be stalled if the reading pointer reaches a data packet 85 being passed into the ring buffer 111. Therefore, if the sizes of the data packets 85 are too large, data overruns may occur in the ring buffer 111. Generally, a data overrun occurs when the storage pointer passes the reading pointer in the ring buffer 111. These data overruns can be prevented, however, by limiting the number of words included in the data portion 91 of the data packets 85.

Furthermore, it is well known that the node latency of any reflective memory system increases as the size of data packets of the system increases. “Node latency” refers to the amount of time required to pass data back out of a node 32 after receiving the data from the network 17. Node latency includes the time required to receive the data, repacketize the data, and pass the repacketized data back to the network 17. The node latency can be limited by limiting the size of the data portions 91 within the packets 85.

Operation

The preferred use and operation of the reflective memory system 30 and associated methodology are described hereafter.

Assume that a local write, referred to hereafter as the “original write,” occurs in one of the nodes 32, referred to hereafter as the “original node 32.” Write data and a memory address, referred to as the “write address,” are transmitted from the bus interface 63 of the original node 32 to the node's reflective memory 24 where the write date is stored at the location corresponding to the write address. Assume for illustrative purposes that the write data is comprised of 128 words of data and that the transmit manager 76 is configured to dynamically control the length of the data portion 91 (FIG. 5) up to a maximum length of 64 words. Note that the write data may be comprised of other numbers of words in other examples, and the transmit manager 76 may be configured to allow a different maximum number of words to be included in the data portion 91 of packets 85 in other embodiments.

The data manager 66 of the original node 32 passes the write data, the write address, and the node identifier of the original node 32 to the transmit FIFO 73. Note that the foregoing write data, write address, and node identifier will be collectively referred to hereafter as the “original write burst.” The data manager 66 also continuously provides a burst identifier of a particular value to the transmit FIFO 73 while passing the data of the original write burst to the transmit FIFO 73. Once all of the data of the original write burst is passed to the transmit FIFO 73, the data manager 66 transitions the burst identifier to a new value.

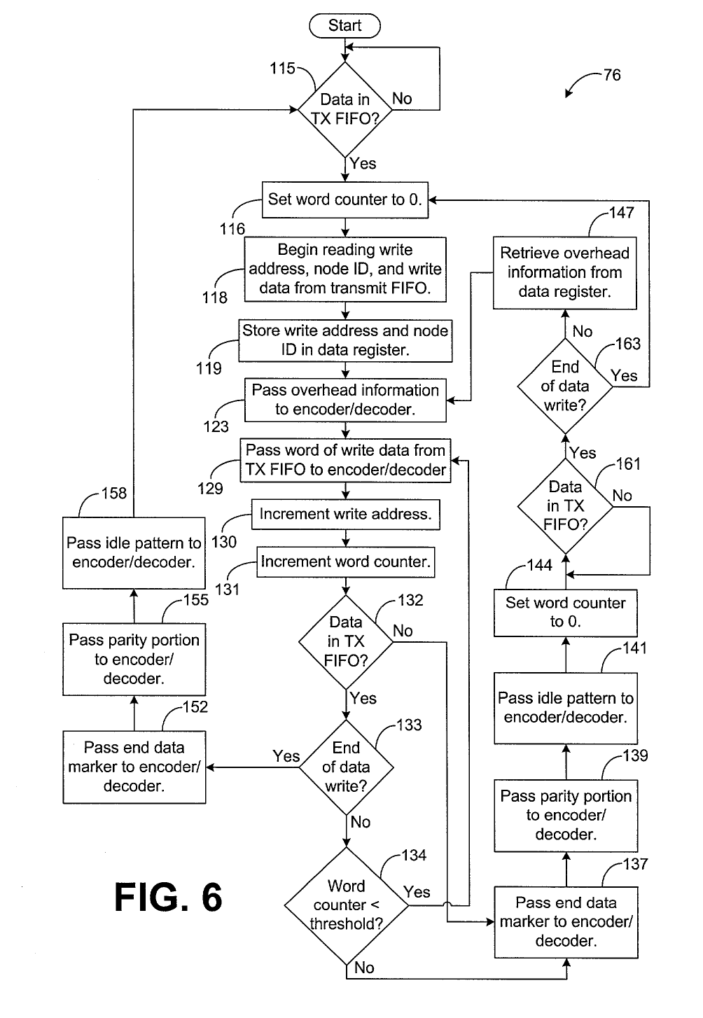

After setting the value within the word counter 101 to zero, the transmit manager 76 begins to read the data of the original write burst out of the transmit FIFO 73, as shown by blocks 115, 116 and 118 of FIG. 6. As shown by blocks 119 and 123, the transmit manager 76 stores the write address and the node identifier in the data registers 99 and passes overhead information to the encoder/decoder 79. This overhead information preferably includes the write address and node identifier stored in the data registers 99. The encoder/decoder 79 encodes, serializes, and passes the overhead information to the transceiver 69.

As shown by blocks 129-134, the transmit manager 76 then passes each word of the write data from transmit FIFO 73 to the encoder/decoder 79 until there is no more write data from the original write burst in the transmit FIFO 73 or until the maximum threshold for the data portion 91 is exceeded. In this regard, the transmit manager 76 detects, in block 132, whether any data is ready to be read out of the transmit FIFO 73. Furthermore, the transmit manager 76, in block 133, reads the next data word out of the transmit FIFO 73 and detects whether the burst ID sample of this next data word is different than the burst ID sample of the data word most recently passed in block 129. Also, in block 134, the transmit manager 76 detects whether the value of the word counter 101 exceeds a predefined threshold, which in the present example is 64. In addition, in block 130, the transmit manager 76 increments the write address that is stored in the data registers 99 in block 119, and in block 131, the transmit manager 76 increments the value of the word counter 101, which was set to zero in block 116.

In the present example, assume that, due to the processing of one or more other packets 85 for an earlier data write, all of the write data from the original write is passed to the transmit FIFO 73 before any of such write data is read from the transmit FIFO 73 by the transmit manager 76. In such a case, the transmit manager 76 should continue looping through blocks 129-134 until 64 words have been passed from the transmit manager 76.

After passing the 64^{th} word, the transmit manager 76 should detect in block 134 that the threshold for the data portion 91 has been exceeded. Therefore, the transmit manager 76 passes a data end marker, parity information, and the idle pattern to the encoder/decoder 79, as shown by blocks 137, 139 and 141. At this point, a first packet 85, including a portion of the write data of the original write, has been defined and passed out of the transmit manager 76. After passing this first data packet 85, the transmit manager 76 then begins to pass a second data packet 85 including the remainder of the write data from the original write.

In this regard, the transmit manager 76 resets the word counter 101 to zero, as shown by block 144, and retrieves the write address (as previously adjusted via implementation of block 130) and the node identifier associated with the original write from the data registers 99, as shown by block 147. Based on the retrieved information, the transmit manager 76 passes, to the encoder/decoder 79 in block 123, the node identifier of the original node 32 and the write address stored in the data registers 99. Note that this write address should indicate the reflective memory location where the data of the following data portion 91 is to be stored in memory 24.

The transmit manager 76 then begins to pass the remaining write data to the encoder/decoder 79 by repeating blocks 129-134. After 64 words have been passed, the transmit manager 76 should detect, in block 133, that there is no more write data from the original write within the transmit FIFO 73. Therefore, the transmit manager 76 passes a data end marker, parity information, and the idle pattern to the encoder/decoder 79, as shown by blocks 152, 155 and 158. At this point, all of the write data from the original write has been packetized and passed out of the transmit manager 76.

It should be noted that all of the blocks shown in FIG. 6 are not necessarily completed in the order shown by FIG. 6. For example, while block 118 may be initiated before blocks 123 and 129-134, the reading of write data in block 118 preferably continues during the occurrences of blocks 123 and 129-134 until all available write data from the original write has been read out of the transmit FIFO 73.

It should also be noted that it is possible, in some examples, for a “no” determination to be made in block 132 before all of the write data of a data write is packetized. Such a situation occurs when the transmit manager 76 has read all of the write data previously passed to the transmit FIFO 76 before the next data word of the data write has been passed to the transmit FIFO 73 and is ready to be read out of the transmit FIFO 73. In such a situation, the transmit manager 76 preferably terminates the current data packet 85, as shown by blocks 137, 139, and 141. The transmit manager 76 then waits until the next data word is ready to be read out of the transmit FIFO 73, and once this data word becomes available, the transmit manager 76, as shown by blocks 161 and 163, proceeds to block 147 and begins a new data packet 85 for the next data word. Note that the same techniques employed to implement blocks 132 and 133 may be employed to implement blocks 161 and 163, respectively.

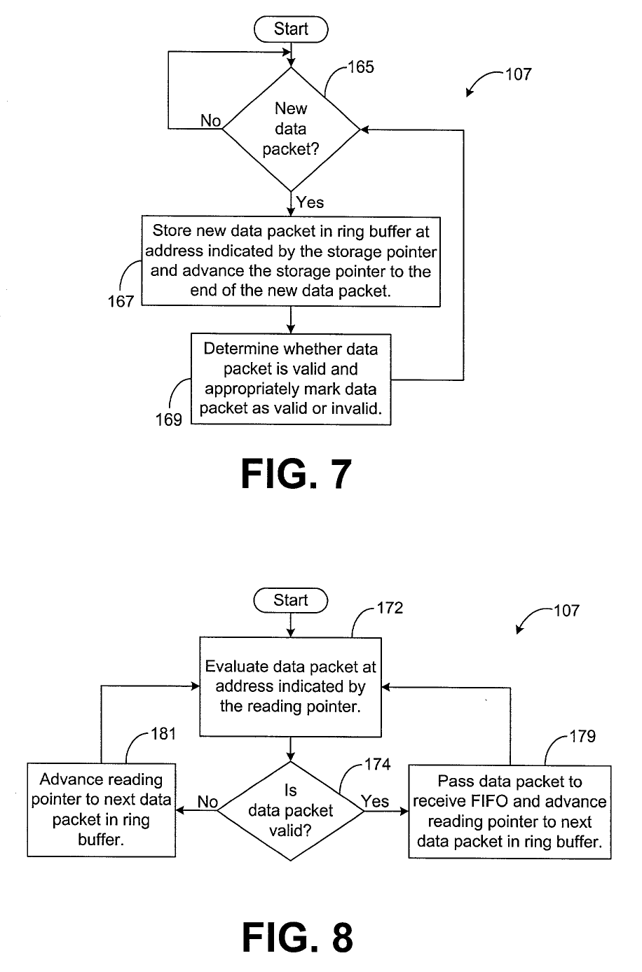

Both of the aforementioned first and second data packets 85 created by the transmit manager 76 are passed to the network 17 via transceiver 69 and routed, by the network 17, to another node 32, which will be referred to hereafter as “the second node 32.” The transceiver 69 of the second node 32 serially receives the first packet 85 and then the second packet 85. After receiving the first packet 85, the transceiver 69 passes the first packet 85 to the encoder/decoder 79, which decodes the first packet 85 and passes the first packet 85 to the receive manager 107. As shown by blocks 165 and 167 of FIG. 7, the receive manager 107 then stores the first packet 85 into the ring buffer 111 at the location pointed to by the storage pointer. The receive manager 107 also advances the storage pointer to the next ring buffer address, which may be the address where the second data packet 85 is stored, as will be described in more detail hereinbelow.

While the first data packet 85 is being stored in the ring buffer 111, the first data packet 85 may be evaluated by the receive manager 107. During the course of evaluating the first data packet 85, the receive manager 107 analyzes the first data packet 85 for parity errors and determines whether the node identifier of the first data packet 85 identifies the second node 32. If the receive manager 107 discovers a parity bit error or that the node identifier of the first data packet 85 identifies the second node 32, then the receive manager 107 marks the first data packet 85 as invalid in block 169. Otherwise, the receive manager 107 marks the first data packet 85 as valid in block 169.

As the receive manager 107 is storing and evaluating data packets 85 from encoder/decoder 79, the receive manager 107 is evaluating for validity the data packets 85 pointed to by the reading pointer in block 172 of FIG. 8. Eventually, the receive manager 107 advances the reading pointer to the ring buffer address of the first data packet 85, and the receive manager 107, therefore, determines whether or not the first data packet 85 has been marked as valid. If the first data packet 85 has been marked as valid, then the receive manager 107 passes the first data packet 85 to the receive FIFO 114, as shown by blocks 174 and 179. In performing block 179, the receive manager 107 preferably advances the reading pointer to the next ring buffer memory address, which preferably is storing the data packet 85 received by the receive manager 107 immediately after receiving the first data packet 85.

If, on the other hand, the first data packet 85 has been marked as invalid, then the receive manager 107 skips the first data packet 85. In this regard, the receive manager 107 advances the reading pointer to the next ring buffer memory address without passing the first data packet 85 to the receive FIFO 114, as shown by blocks 174 and 181 of FIG. 8. In such a case, the first data packet 85 is eventually overwritten without being passed to receive FIFO 114 and, therefore, without being stored to the reflective memory 24 of the second node 32. In the present example, assume that the first data packet 85 is marked as valid and is, therefore, passed to the receive FIFO 114.

Note that the processes shown by FIGS. 7 and 8 may be performed concurrently by the receive manager 107. For example, as the first data packet 85 is being evaluated by the receive manager 107 in block 172, the receive manager 107 may be writing the second data packet 85 to the ring buffer 111.

When the data manager 66 reads the first data packet 85 out of the receive FIFO 114, the data manager 66 writes the write data of the first data packet 85 into memory 24 at the address identified by the write address of the first data packet 85. Thus, the reflective memory 24 of the second node 32 is updated based on the original write that occurred in the original node 32. The data manager 66 also passes the write address and the write data from the first data packet 85 to the transmit FIFO 73. The write data is then repacketized by the transmit manager 76 and transmitted to yet another node 32 according to the techniques described above.

Once the second data packet 85 is received by the second node 85, the second data packet 85 is stored in the ring buffer 111 and evaluated according to the same techniques described above for the first data packet 85. Note that if the second data packet is received by the second node 85 after the first data packet 85 without any intervening data, then the second packet 85 should be stored in the next address of the ring buffer 111 referred to above. If the second data packet 85 is determined to be valid, then the write data of the second data packet 85 is stored in the reflective memory 24 of the second node 32. The write data of the second data packet 85 is then repacketized and transmitted to the same node 32 as the repacketized data from the first data packet 85.

Moreover, the foregoing process is repeated for each node 32 within the system 30 until the first and second data packets 85 eventually arrive at the original node 32. Once this occurs, the reflective memory 24 for each of the nodes 32 of the system 30 has been updated for the original write. Therefore, the process of transmitting the write data of the original write to the nodes 32 of the system 30 is terminated. In this regard, the original node 32 determines, in block 169 of FIG. 7, that it is identified by the node identifiers of the first and second packets 85. Thus, the original node 85 marks the first and second data packets 85 as invalid and skips over the first and second data packets 85 in the ring buffer 111 without passing data from the first and second data packets 85 to the receive FIFO 114. As a result, the first and second data packets 85 are eventually overwritten or, in other words, discarded.

By implementing the aforedescribed techniques for each local data write that occurs within the system 30, the memory 24 within the system 30 maintains its reflective nature. In this regard, a data write that originally occurs within the memory 24 of any one node 32 is repeated for each of the other nodes 32 within the system 30. Thus, the memory 24 of any one node 32 should correspond to the memory 24 of each of the other nodes 32.

It should be noted that it is not necessary for the transmit manager 76 to update, via block 130 in FIG. 6, the write address within data registers 99 each time a data word is passed to the encoder/ decoder 79. For example, the transmit manager 76 may utilize the value in the word counter 101 to adjust the write address after passing the data portion 91 of a data packet 85 to the encoder/decoder 79. In this regard, the foregoing value should indicate the number of data words included in the data portion 91. Thus, the transmit manager can add the value in the counter 101 to the write address once the data portion 91 has been passed and then overwrite the stored write address with the calculated sum in order to appropriately update the write address. Other techniques in other embodiments may be employed to update the write address.

It should also be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Now, therefore, the following is claimed:

1. A reflective memory unit, comprising:
reflective memory;
a first buffer;
a data manager configured to pass write data to the first buffer in response to a data write for writing the write data to the reflective memory;
a transmit manager configured to read the write data from the first buffer and to packetize at least a portion of the write data into a data packet, the transmit manager further configured to dynamically control a length of the data packet based on an amount of the write data read from the first buffer by the transmit manager; and
a communication manager configured to serially transmit the data packet to a network.

2. The reflective memory unit of claim 1, wherein the transmit manager is configured to determine a value indicative of an amount of the write data included in the data packet and to perform a comparison between the value and a threshold, the transmit manager configured to terminate the data packet based on the comparison and to packetize, into at least one other data packet, a remaining portion of the write data.

3. The reflective memory unit of claim 1, wherein the communication manager is further configured to receive a data packet from the network, and wherein the reflective memory unit further comprises:
a second buffer; and
a receive manager configured to store the received data packet into a ring buffer and to analyze the received data packet while the received data packet is stored in the ring buffer, the receive manager further configured to selectively pass, to the second buffer, write data from data packets stored in the ring buffer based on an analysis of the stored data packets by the receive manager,
wherein the write data passed to the second buffer by the receive manager is written into the reflective memory.

4. The reflective memory unit of claim 1, wherein the transmit manager is configured to include a memory address in the data packet, the memory address indicative of a location in the reflective memory where the write data is stored in response to the data write, the transmit manager configured to store the memory address in at least one register and to include a remaining portion of the write data in at least one other data packet, the transmit manager further configured to include, in the at least one other data packet, a memory address based on the stored memory address.

5. The reflective memory unit of claim 4, wherein the transmit manager is configured to adjust the stored memory address based on an amount of the write data packetized by the transmit manager.

6. A reflective memory system, comprising:
a network; and
a plurality of nodes communicatively coupled to the network, each of the nodes having reflective memory, the nodes configured to update the reflective memory in each of the nodes in response to a local data write for writing write data to one of the nodes, the one node configured to packetize a portion of the write data into a data packet and to transmit the data packet to another of the nodes via the network, the one node comprising a buffer and configured to pass the write data to the buffer, the one node further configured to dynamically control a length of the data packet based on an amount of the write data within the buffer when the node is forming the data packet.

7. The reflective memory system of claim 6, wherein the one node is configured to determine a value indicative of the amount of the write data included in the data packet and to perform a comparison between the value and a threshold, the one node further configured to terminate the data packet based on the comparison and to packetize, into at least one other data packet, a remaining portion of the write data.

8. The reflective memory system of claim 6, wherein the one node is configured to receive data packets from the network and to store the received data packets into a ring buffer, the receive manager further configured to pass write data from the received data packets out of the ring buffer based on an analysis of the stored data packets by the one node.

9. The reflective memory system of claim 6, wherein the one node is configured to include a memory address and a node identifier in the data packet, the memory address indicative of a location in the reflective memory of the one node where the write data is stored in response to the data write and the node identifier identifying the one node, the one node comprising at least one data register and configured to store the memory address and the node identifier in the at least one data register, the one node further configured to packetize a remaining portion of the write data into at least one other data packet and to include the stored node identifier and a memory address based on the stored memory address in the at least one other data packet.

10. The reflective memory system of claim 9, wherein the transmit manager is configured to adjust the stored memory address based on an amount of the write data packetized by the transmit manager.

11. A reflective memory unit for use in a reflective memory system, the reflective memory system including a communication network, comprising:
reflective memory; and
a transmit manager configured to packetize, into a plurality of data packets, write data that is associated with data writes to said reflective memory, the transmit manager further configured to dynamically size the plurality of data packets and to cause the data packets to be transmitted to the communication network.

12. The reflective memory unit of claim 11, wherein the transmit manager is configured to store a memory address indicative of a location in the reflective memory where write data associated with one of the data writes is stored, the transmit manager configured to adjust the stored memory address based on an amount of the write data packetized by the transmit manager for the one data write, the transmit manager further configured to include the adjusted memory address in one of the data packets that includes a portion of the write data associated with the one data write.

13. The reflective memory unit of claim 1 1, wherein the transmit manager is configured to determine a value indicative of an amount of the write data included in one of the data packets and to perform a comparison between the value and a threshold, the transmit manager configured to terminate the one data packet based on the comparison.

14. The reflective memory unit of claim 11, wherein the reflective memory unit further comprises a receive manager configured to receive at least one data packet from the communication network and to store the at least one data packet into a ring buffer, the receive manager further configured to evaluate the at least one data packet and to cause a data write to the reflective memory based on the at least one data packet if the receive manager determines that the at least one data packet is valid.

15. A method for use in a reflective memory system, the reflective memory system comprising a plurality of nodes communicatively coupled to a network, each of the nodes having reflective memory, the method comprising the steps of:
storing write data to the reflective memory in one of the nodes;
updating the reflective memory within each of the other nodes based on the write data stored in the storing step,
wherein the updating step comprises the steps of:
passing the write data to a first buffer within the one node;
successively reading a portion of the write data from the first buffer;
packetizing the write data read in the reading step into a data packet;
dynamically controlling a length of the data packet based on an amount of write data read in the reading step; and
serially transmitting the data packet to the network.

16. The method of claim 15, wherein the updating step further comprises the steps of:
determining a value indicative of an amount of data read in the reading step;
comparing the value to a threshold;
terminating the packetizing step based on the comparing step;
reading a remaining portion of the write data from the first buffer;
packetizing, into at least one other data packet, the remaining portion of the write data; and
serially transmitting the at least one other data packet to the network.

17. The method of claim 15, wherein the updating step further comprises the steps of:
receiving the data packet at another of the nodes;
storing the received data packet in a ring buffer at the other node;
analyzing the stored data packet; and
selectively writing the write data from the stored data packet into the reflective memory of the other node based on the analyzing step.

18. The method of claim 15, wherein the updating step further comprises the steps of:
storing a memory address and a node identifier into at least one data register at the one node, the memory address indicating a location in the reflective memory of the one node where the write data is written in response to the storing step, and the node identifier identifying the one node;
including the memory address and the node identifier in the data packet;
packetizing a remaining portion of the write data into at least one other data packet; and
including, in the at least one other data packet, the stored node identifier and a memory address based on the stored memory address.

19. The method of claim 18, further comprising the steps of:
adjusting the stored memory address based an amount of the write data read in the reading step.

20. A method for use in a reflective memory system, the reflective memory system including a plurality of nodes communicatively coupled to a communication network, the method comprising the steps of:
detecting data writes to reflective memory within the reflective memory system;
packetizing, into a plurality of data packets, write data associated with the data writes;
dynamically sizing the data packets; and
communicating the data packets to the plurality of nodes via the communication network.

21. The method of claim 20, further comprising the steps of:
storing a memory address indicative of a location in the reflective memory where write data associated with one of the data writes is stored;
adjusting the stored memory address based on an amount of the write data packetized for the one data write; and
including the adjusted memory address in one of the data packets that includes a portion of the write data associated with the one data write.

22. The method of claim 20, further comprising the steps of:
determining a value indicative of an amount of the write data included in one of the data packets;
performing a comparison between the value and a threshold; and
terminating the one data packet based on the comparison.

23. The method of claim 20, further comprising the steps of:
receiving at least one data packet from the communication network;
storing the at least one data packet into a ring buffer;
evaluating the at least one data packet while the at least one data packet is stored in the ring buffer; and
writing data from the at least one data packet to the reflective memory if the at least one data packet is determined to be valid via the evaluating step.
